(19) United States
(12) Patent Application Publication
(10) Pub. No.: US 2009/0228963 A1
(43) Pub. Date: Sep. 10, 2009

(54) CONTEXT-BASED NETWORK SECURITY

(75) Inventors: Andrew K. Pearce, San Francisco, CA (US); Roy L. Chua, Cupertino, CA (US); Shirish Rai, Albany, CA (US); John Christopher Evans Radkowski, Los Altos Hills, CA (US); Sean Joseph Convery, Mountain View, CA (US)

Correspondence Address: KOLISCH HARTWELL, P.C., 200 PACIFIC BUILDING, 520 SW YAMHILL STREET, PORTLAND, OR, 97204, US

(73) Assignee: NORTEL NETWORKS LIMITED, Ottawa (CA)

(21) Appl. No.: 12/323,002

(22) Filed: Nov. 25, 2008

Related U.S. Application Data
(60) Provisional application No. 60/990,082, filed on Nov. 26, 2007.

(51) Int. Cl. G06F 21/00; G06F 15/16; H04L 9/32

(52) U.S. Cl. 726/5; 709/229; 726/11; 707/200

(57) ABSTRACT

Context-based network security is provided for streamlined access control over a computer network and components on the computer network. More particularly, methods, instructions on computer-readable media and systems are provided for collecting network context information about a client computer system connecting to the computer network, making the network context information available to various components on the computer network, and using the network context information to control the client computer system's (or a client application executing thereon) access to one or more network resources.

### CROSS REFERENCE TO RELATED APPLICATIONS

This application claims priority under 35 U.S.C. §119(e) to U.S. Provisional Patent Application No. 60/990,082 entitled “Network Context Service,” filed Nov. 26, 2007, the disclosure of which is incorporated herein by reference. Additionally, Segmented Network Identity Management is provided in U.S. patent application Ser. No. 11/996,735, filed Jun. 23, 2008. Distributed Authentication, Authorization and Accounting are provided in PCT Application Publication No. WO2008/076760. All patents, patent application publications and publicly available documents referred to herein are hereby incorporated by reference in their entirety for all purposes.

### FIELD OF THE DISCLOSURE

The present disclosure relates to computer network security, and more particularly to methods, systems and instructions on computer-readable media for collecting network context information from various network components and making such information available to other network components for security purposes.

### BACKGROUND

A client device, computer system, service, client application or other entity wishing to access a network resource, such as a network application, service, or other network component, may encounter multiple levels of security. A network-level authentication system may provide a first level of network security. A client device, computer system, user, or service may be required to provide network-level authentication credentials (e.g., a username and password, token, ticket, assertion, or other) to a network access controller (“NAC”). The NAC may forward the provided network-level credentials to an Authentication, Authorization and Accounting (“AAA”) server executing on a computer system, which may authenticate the network-level credentials against a credential database. This process is known as “Authentication.”

The AAA server may utilize additional parameters to permit, deny, restrict or otherwise personalize the client computer system's access to the computer network. These additional parameters may include information about the client computer system (e.g., hardware or software configuration), the network connection (e.g., connection type/speed, access method), and attributes related to the user of the client computer system (e.g., groups of which the user is a member), to name a few. This process is known as “Authorization.”

If the network-level credentials match an entry in the credential database, and the additional parameters are satisfactory, the AAA system may provide the NAC with authentication and authorization responses. The NAC may in turn use the responses to permit, deny, restrict or personalize access by a client computer system to the computer network (e.g. leasing the client device an IP address). IEEE 802.1X is a common example of a protocol implemented by such a system.

Network applications, services or other components executing on the network (hereafter referred to as “network applications”) may enforce a second level of security in the form of application-level authentication. These network applications often require that a client application (e.g., a client or server computer program) executing on a client computer system provide application-level credentials before the network application will communicate with the client application further or provide the client application with access to a network resource. Application-level credentials may take various forms, such as user login credentials, tokens, tickets, assertions, or cookies. Even though such credentials may be authenticated against the same credential database as was used by the AAA system, a user of the client computer system nevertheless may be required to provide the same credentials multiple times. Additionally, the network applications do not have access to any additional information about the client computer system aside from the application-level credentials. For example, network applications currently have no way of determining whether a client application is executing on a local computer system (e.g., in the same local area network) or remotely (e.g., via VPN).

### SUMMARY

Context-based network security is provided for streamlined access control over a computer network and components on the computer network. More particularly, methods, instructions on computer-readable media and systems are provided for collecting network context information about a client computer system connecting to the computer network, making the network context information available to various components on the computer network, and using the network context information to control the client computer system's (or a client application executing thereon) access to one or more network resources.

In one aspect, a client computer system desiring access to a computer network provides network context information about the client computer system to a computer system (e.g., a AAA server). In another aspect, a computer system collects network context information from various components, including a client computer system, and stores the network context information in a network context database. In another aspect, a computer system provides one or more network applications or other network components with access to the network context information contained in the network context database. In another aspect, a network application or session manager obtains network context information from a network context server and controls a client application's access to a network resource based at least partially on the network context information.

Network context information may include information about the client computer system, such as its hardware/software configuration, health, network connection method, geographic location, and the like. Network context information may also include information about the user of the client computer system, such as the user's group membership, title, seniority in an organization, and the like. Network context information may also include authorization status, such as whether the client computer system is restricted to a particular region of a computer network or prohibited from particular network resources.

Other aspects and features of the present disclosure will become apparent to those ordinarily skilled in the art upon review of the following description of specific embodiments in conjunction with the accompanying figures.

### BRIEF DESCRIPTION OF THE DRAWINGS

FIG. 1 is a diagram showing an example system implementing context-based security.

FIG. 2 is a diagram showing example processes used to authenticate a client computer system to a network and collect network context information from the client computer system.

FIG. 3 shows an example process of authenticating a client application to a particular network application executing on the network using, in addition to traditional application-level credentials, network context information.

FIG. 4 depicts an example request a network application may send to a network context server to obtain network context information.

### DETAILED DESCRIPTION

As discussed above, after a client computer system is authenticated at the network level, a client application initiated directly or indirectly from the client computer system may be required to authenticate again to one or more network applications at the application level using application-level credentials. However, network applications may be able to make safer, more informed decisions about allowing a client application or service access to various resources if the network application has further information about the client application, client computer system, client's network connection, or other similar information (i.e. network context information) beyond mere application-level credentials.

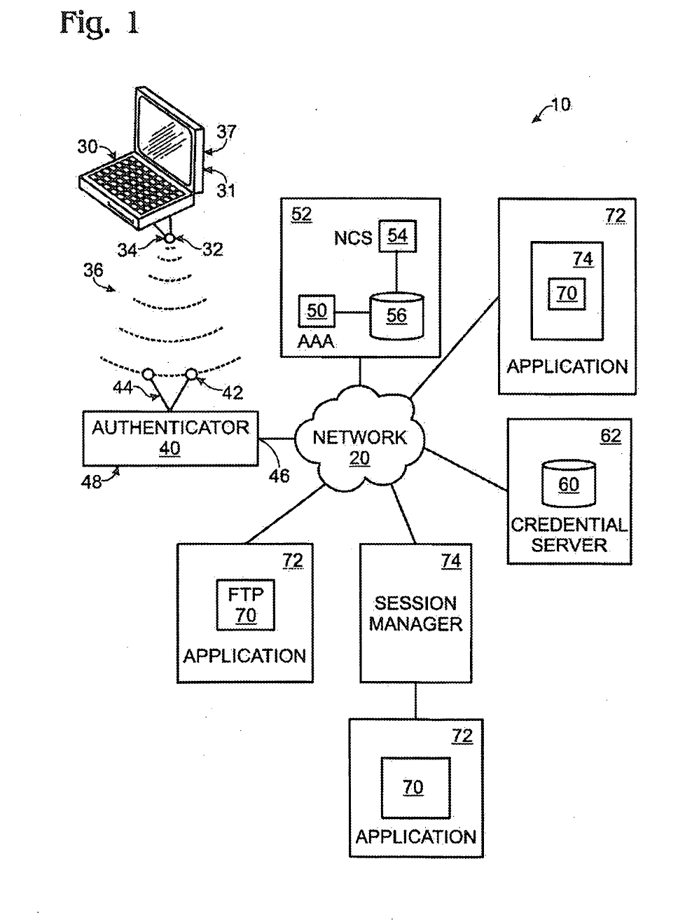

Therefore, as seen in FIGS. 1-3, systems, methods, and instructions on computer-readable media are provided for collecting network context information from various network components and making such information available to other network components operating on a computer network 20. Referring to the example depicted in FIG. 1, a system 10 may include: a network 20; a client computer system 31 executing a supplicant 30 and one or more client applications 37; a NAC 48 executing an authenticator 40; a computer system 52 executing an AAA server 50 and/or a network context server 54; a computer system 62 hosting a credential database 60; and one or more network application computer systems 72 executing one or more network applications 70. Computers systems (31, 52, 62 or 72) may be one or more computers or other devices with memory, instructions in the memory, and processors configured to execute the instructions.

Network context information may include information about a client computer system or a user thereof beyond mere network or application-level credentials, such as information about the client computer system, information about the user, network connection information, and authorization status of the client computer system.

Information about client computer system 31 may include hardware configuration (e.g. processor characteristics, amount of memory, software configuration, network and/or geographic location, and health. The health of client computer system 31 may include information pertaining to the level of security implemented on client computer system 31, such as whether anti-virus software is installed, the type of anti-virus software, how up-to-date that virus software is, current virus, worm, or other infections, information about the level of firewall protection configured on or in relation to client computer system 31, and other similar information.

Information about the user (also referred to as “user information”) may include the user's name, address, organizational role, title, group membership or other such characteristics. User information may be obtained from client computer system 31 and/or other network components, such as credential database 62 (see FIG. 1). In cases where client computer system 31 is a server or other computer system that is not being controlled by a user, however, user information may not be relevant.

Network connection information may include the type and characteristics of a client computer system's connection, connection status, connection conditions (e.g. virtual LANs to which the client device/user is limited), and connection protocols used. Network connection information may also include the location of, hardware and/or software configuration of, and information pertaining to a NAC 48 via which client computer system 31 connects to computer network 20.

Authorization status may include information about the authentication and/or authorization states of client computer system 31, and other similar information. Authorization status may include static, dynamic, or calculated information about the conditions under which client computer system 31 (or a user thereof) is connected to computer network 20, such as time of day restrictions, resources the client device/user thereof may or may not access (e.g., VLANS), or other such authorization-related information. Authorization status also may include results of rules calculated from the combination of conditions including client computer system, user, and network connection information.

While terminology specific to 802.1X (e.g., “supplicant”) is used extensively in this disclosure, it should be understood that any network authentication protocol may be used, and that each component shown in FIG. 1 is not limited to a role under 802.1X. For instance, client computer system 31 may be a device configured to authenticate to computer network 20 using other network authentication schemes.

Referring to FIG. 1, computer network 20 may be a local area network (“LAN”), multiple LANs in communication with each other, a wide-area network, or the Internet. Devices connected to computer network 20 may utilize various data link protocols to communicate (i.e., transmit information to one another) across computer network 20, such as IEEE 802.3 (“Ethernet”), wireless (e.g., 802.11), Token Ring, or other protocols known in the art.

Client computer system 31 may be one or more computer devices capable of connecting to computer network 20, such as a laptop computer, desktop computer, computer mainframe, server computer, personal digital assistant, cellular phone, or other devices capable of connecting to computer network 20. Client computer system 31 may be configured with a network interface 32, such as a wireless transmission device 34 emitting transmission waves 36. It should be understood that other network interfaces 32, including interfaces configured to connect to wire networks using cables, are contemplated. It should further be understood that while reference is made repeatedly to wireless client connections, virtual private network (“VPN”) and other connection types are also contemplated.

A supplicant 30 may be executing on client computer system 31. Supplicant 30 may be configured to communicate with an authenticator 40 executing on NAC 48 to obtain network access for client computer system 31. Supplicant 30 may be further configured to collect network context information, such as information about client computer system or its network connection, and forward this information to AAA server 50 and/or network context server 54.

In addition to supplicant 30, client computer system 31 may be configured with other software, herein referred to as one or more client applications 37, each configured to communicate with one or more network applications 70. Client applications 37 may include computer programs such as web browsers, email clients, servers, or any other computer program capable of communicating with one or more network applications 70. Client applications 37 may be executed by a user, on behalf of a user, or may be unrelated to a particular user. In the latter case, client applications 37 may be executed by a service or other computer program on behalf of client computer system 31. Network applications 70, which will be discussed further below, may include computer programs accessible via on or more client applications 37 running on client computer system 31.

NAC 48 may be a computer system, or alternatively, NAC 48 may be an appliance-type device (e.g., Firewall, Switch, VPN gateway, etc). Authenticator 40 may be a program executing on NAC 48 and configured to control access to computer network 20. Because in many embodiments NAC 48 acts exclusively as authenticator 40, the terms, “authenticator” and “NAC” are used interchangeably. Authenticator 40 may be configured to communicate with one or more supplicants 30 in order to control network access for the one or more client computer systems 31 on which the one or more supplicants 30 are executing. NACs 48 may include one or more network interfaces 42, such as a wireless transmitter 44 configured to receive a wireless transmission signal 36, and/or another network interface 46 configured to connect to computer network 20. It should be understood that the network interfaces (e.g., 44, 46) may include interfaces configured to connect to wired networks using cables (e.g., where the NAC 48 acts as a VPN gateway).

Communications between supplicant 30 and authenticator 40 may occur using a number of data link layer protocols. In wireless networks, protocols such as the IEEE 802.11 standards may be used. In wired networks, Ethernet, Token Ring, or other such protocols may be used. On top of these data link layer protocols, network-level authentication protocols, such as the Extensible Authentication Protocol (“EAP”) and/or its sub-variants, may be used to encapsulate communications between supplicants 30 and authenticators 40 related to network authentication/authorization. The EAP standard is described in Request for Comments (“RFC”) 3748, published by the Internet Engineering Task Force (“IETF”), and is incorporated herein in its entirety for all purposes. When EAP is used over one of the above-mentioned wired or wireless network types, it is often referred to as Extensible Authentication Protocol Encapsulated over LAN, or EAPOL. The 802.1X standard is based on the use of EAPOL.

As noted above, AAA server 50 may be a computer program executing on a computer system 52 connected to computer network 20. AAA server 50 may be configured to communicate with various components of system 10 in order to provide and control access by client devices 31 to computer network 20.

AAA server 50 may be configured to communicate with authenticator 40 using various protocols, such as the Remote Authentication Dial-In User Services (“RADIUS”) protocol. The RADIUS protocol is described in RFC 2865, also published by the IETF, which is hereby incorporated by reference in its entirety for all purposes. In particular, authenticator 40 may forward to AAA server 50 credentials submitted by client computer system 31 and/or the user thereof requesting access to computer network 20. AAA server 50 likewise may be configured to communicate with credential database 60 hosted on computer system 62 using a compatible communication protocol (e.g., lightweight directory access protocol (“LDAP”)), in order to authenticate the submitted credentials. Additionally, AAA server 50 may authorize client computer system 31 to computer network 20, as will be discussed further below.

AAA server 50 may also collect network context information from various components on computer network 20. To this end, AAA server 50 may be further configured to communicate with other components of the system 10 such as client computer system 31. NAC 48, client application 37, one or more network applications 70 and associated session managers 74. Such communications between AAA server 50 and these components may occur using various communication protocols such as 802.1X, RADIUS, DIAMETER, EAPOL, EAP, Security Assertion Markup Language (“SAML”) or other similar protocols.

Using the above-described communications and protocols, AAA server 50 and/or network context server 54 may be configured to collect network context information and store it in a network context database 56. Network context database 56 may reside on computer system 52, or on another computer system on computer network 20, or in another location that is in network communication with computer system 52.

Network context server 54 may be a computer program configured to communicate with network context database 56 in order to make network context information available to one or more network applications 70 and/or session managers 74. Although network context server 54 is shown executing, on the same computer system 52 as the AAA server 50, and may in some embodiments even be incorporated into the same daemon, it should be understood that in other embodiments, network context server 54 may execute on a different computer system from AAA server 50. Network context server 54 may communicate with various components in various protocols. In some embodiments, network context server 54 may be configured to communicate with network applications 70 and session managers 74 using communication protocols such as the Service Oriented Architecture Protocol (“SOAP”: formerly known as Simple Object Access Protocol), LDAP, XML-RPC, JSON-RPC, BEEP, or other similar protocols.

SOAP, which is based on the eXtensible Markup Language (“XML”), is a protocol used to exchange messages over computer networks. It is typically transported using application layer protocol such as HTTP or HTTPS. The most common messaging pattern for which SOAP is implemented is the remote procedure call (“RPC”) pattern, in which one network node (the client) sends a request message to another node (the server), and the server immediately sends a response message to the client.

Credential database 60 executing on computer system 62 may come in various forms, such as Microsoft® Active Directory (“AD”), LDAP, Novell® eDirectory, Sun® Java System Directory Server, or other similar credential databases used for storing user information for authentication purposes. Credential database 60 may provide network-level and/or application-level authentication.

One or more network applications 70 may be running on one or more computers 72 which are connected to computer network 20. Network applications 70 may require application-level authentication. Without being limiting in any way, network applications may include hypertext transfer protocol servers (“HTTP”, also referred to as web servers), file transfer protocol (“FTP”) services, email services (e.g., Microsoft® Exchange, simple mail transfer protocol “SMTP”), and database servers (e.g., MS SQL Server, MySQL, Informix). Network applications 70 may also be referred to as network services or servers.

Credentials used for network-level and/or application-level authentication may include a sequence of computer-readable characters or information. In many examples, user credentials comprise a username and a password. In other examples, user credentials may comprise a digital representation of a physical characteristic or biometric of the user of the client computing device, such physical characteristics including but not limited to fingerprint, retina image, or other characteristics suitable for use in an authentication scheme. In still other examples, user credentials may comprise a combination of digital certificates, identification numbers, tokens, cookies, SAML assertions, or the like.

One or more of the above-described components may be configured to initialize and/or control a session. A session is a lasting application-level connection between two entities which may include a client application 37 and a network application 70. Sessions may be implemented as a layer in a network protocol. Sessions may begin immediately after authentication, and may end when the entities involved are finished communicating.

Some network applications 70 may have session services 74, which may be a part of or separate from the application itself. Session service 74 may initiate and/or control sessions for network application 70. Some session services 74 may perform session management for more than one network application 70.

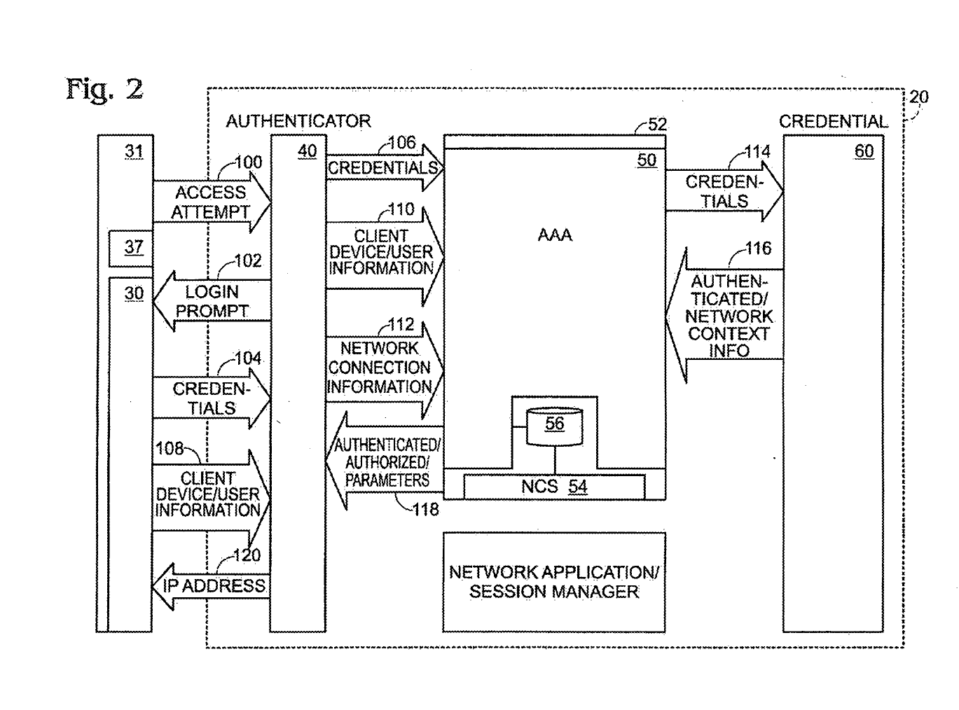

FIG. 2 depicts a first aspect relating to the collection of network context information, including a network authentication and authorization process implemented on a system similar to the one depicted in FIG. 1, utilizing the same reference numerals as FIG. 1. In step 100, client computer system 31 attempts to access computer network 20 by instructing supplicant 30 to send a communication to authenticator 40. Authenticator 40 responds in a step 102 by prompting supplicant 30 for network-level credentials.

In some examples, such as the example depicted in FIG. 2, the response sent in step 102 may include a login prompt asking the user of client computer system 31 to furnish her username and password. Other network-level credentials, described in detail above, could also be requested by AAA server 50. While any communication protocol may be used in this authentication conversation between supplicant 30 and authenticator 40, in many examples, this conversation will occur using the 802.1X protocol (i.e., EAPOL).

Upon receipt of network-level credentials input by the user (or, if no user is involved, supplicant 30 may acquire the credentials from another source, such as a local data store), supplicant 30 may communicate in step 104 the credentials to authenticator 40. Authenticator 40 may in turn route the credentials to AAA server 50 in step 106.

Supplicant 30 also may be configured to collect network context information and forward it to authenticator 40 in step 108. For instance, supplicant 30 may be modified, either within its source code or via one or more plug-in modules, to collect network context information. Information collectable by supplicant 30 may include information about client computer system 31, network connection information and information about the user of client computer system 31. Authenticator 40 may forward the network context information to AAA server 50 (or network context server 54 in some embodiments) in step 110. Independently of steps 108-110, authenticator 40 may be configured to communicate network connection information to AAA server 50 in step 112.

AAA server 50 may store the network context information in network context database 56. While steps 104-112 are shown in a particular sequence in FIG. 2, it should be understood that these steps may occur in various sequences. For instance, the supplicant may be configured to forward network context information to authenticator 40 before sending the credentials, instead of after.

Some time after AAA server 50 receives the network-level credentials, it may in step 114 authenticate the credentials against credential database 60. In embodiments where computer system 62 upon which credential database 60 is executing is separate from AAA server computer system 52, this step may include transmitting request for authentication from AAA server 50 to credential database 60 over computer network 20. Credential database 60 returns in a step 116 an authentication response (e.g., authenticated or denied) to the AAA server 50. The credential database 60 also may be configured to return in step 116 additional network context information, such as user information. The AAA server 50 (or network context server 54) may store this additional network context information in the network context database 56.

In some embodiments, AAA server 50 may have a copy of at least some of the network-level credentials from credential database 60 cached in the memory of AAA computer system 52. In such cases, steps 114 and 116 may not be necessary, as AAA server 50 can simply authenticate the received credentials using its own cached copy and generate its own authentication response.

AAA server 50 then may generate and communicate at step 118 network authentication and authorization responses to authenticator 40. In some embodiments, the authentication and authorization responses are combined into a single communication. These responses may be usable by authenticator 40 to permit, deny or otherwise control access to computer network 20. For example, the authentication response may be usable only to permit or deny access to client computer system 31, while the authorization response may contain more detailed provisioning parameters based on policy rules, which may grant, deny, restrict or otherwise personalize access of client computer system 31 to computer network 20. In some embodiments, the authorization response may be based at least partially on network context information. In the example shown in FIG. 2, at step 120, authenticator 40 grants supplicant 30 access by providing client computer system 31 with an IP address.

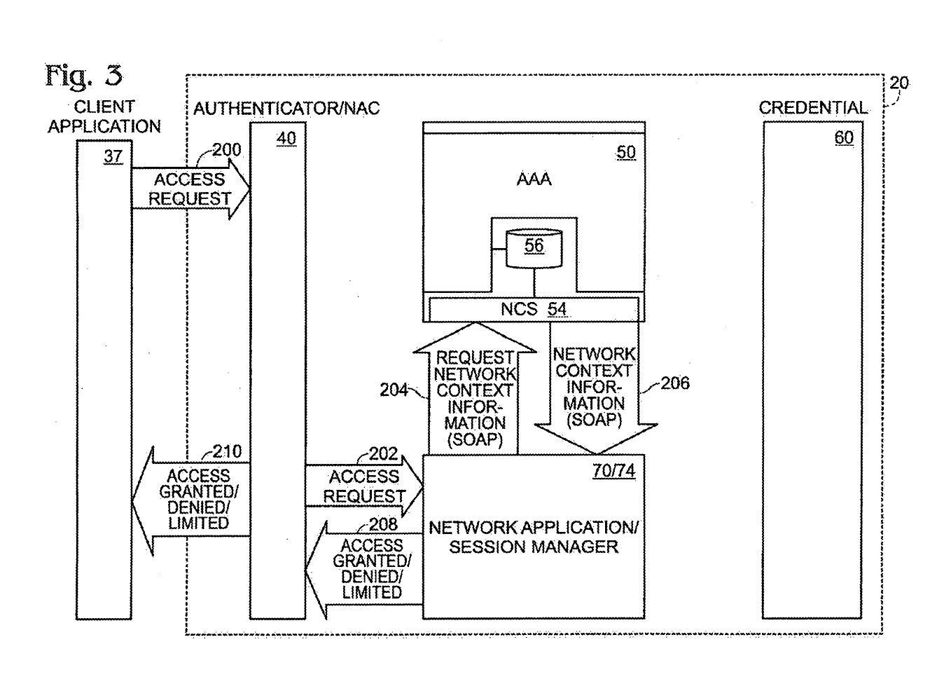

A second aspect for providing network context information to components on a computer network is depicted in FIG. 3. One or more network applications 70 and/or session managers 74 may be configured to communicate with network context server 54 (which may be part of AAA server 50 in some embodiments) to obtain network context information. Network applications 70 and/or session managers 74 may be configured to restrict access by client application 37 to one or more network resources, or to perform session management, based on this network context information.

Client application 37, executing on a network-authenticated client computer system 31 (not shown in FIG. 3), communicates in step 200 an access request addressed to a particular network application 70 or session manager 74, which NAC 48 routes to the appropriate destination at step 202. Upon receiving the access request, network application 70 and/or session manager 74 may be configured to request network context information from network context server 54 at step 204. In order to obtain network context information in a compatible format, such requests may occur using communication protocols such as SOAP, LDAP, XML-RPC, JSON-RPC, BEEP, or other similar protocols.

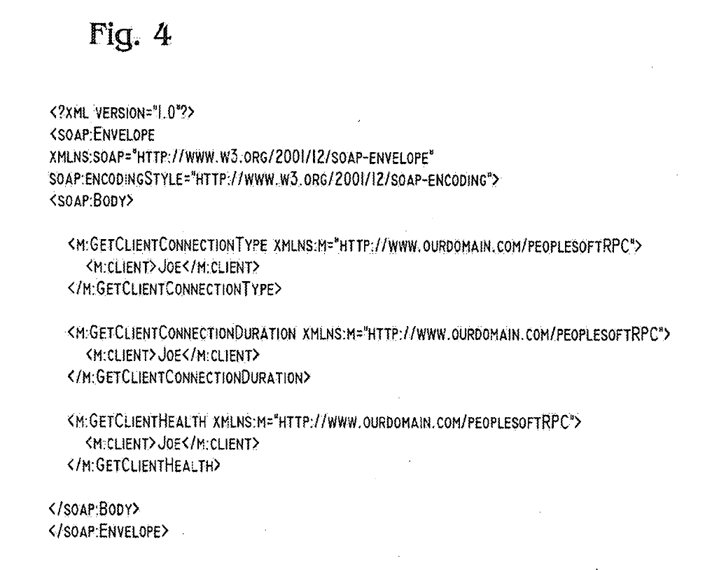

An example SOAP request is depicted in FIG. 4. Shown in XML format, this information includes a network application's request for client connection type, client connection duration, and client health associated with the user name “Joe”. The SOAP response returning the requested information may appear similar. Additionally or alternatively, the response may be customized dynamically to send specific parameters or context components as requested.

After obtaining the requested network context information from network context database 56, in step 206, network context server 54 may communicate the requested network context information to network application 70 or session manager 74. Such a communication may occur using a SOAP response, among other types. Some network applications 70 thereafter may be configured to grant, deny, restrict or personalize access by client application 37 to network resources controlled by network application 70, based on parameters contained in the received network context information. Alternatively, session managers 74 may use network context information to control a session between client application 37 and network application 70.

For example, network application 70 may be configured to allow client computer systems 31 connecting to the computer network 20 via hard-wire connection to access a given network resource, while denying access to the resource to client computer systems 31 connecting to the computer network 20 using wireless technology. In steps 208-210, network application 70 or session manager 74 may transmit to client application 37 an indication of whether access is granted, denied, or restricted, and network application 70 or session manager 74 may thereafter control access of client application 37 to a network resource accordingly. Additionally, network application 70 may restrict or repurpose its features and data based on the network context information.

In some embodiments, network applications 70 may be configured to compare elements of network context-information, and grant, deny or control access to a network resource by a client application 37 based upon the comparison. For example, network application 70 may determine whether the connection method of a client computer system 31 received from a NAC 48 correlates with a connection method received from the client computer system 31. If there is inconsistency (which may indicate an unauthorized intruder mimicking a connection method), network application 70 may limit or deny access to the client application 37.

As with supplicants 30, network applications 70 and session managers 74 may require modification, via plug-ins or other such means, to communicate with network context servers 54. Such modification may include configuring network application 70 to receive and send packets conforming to a certain protocol, such as SAML, SOAP, LDAP, or other such protocols.

Accordingly, while embodiments have been particularly shown and described with reference to the foregoing disclosure, many variations may be made therein. The foregoing embodiments are illustrative, and no single feature or element is essential to all possible combinations that may be used in a particular application. Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A method of implementing context-based security on a computer network, the method comprising:
receiving, at a network application server, a request from a client application executing on a client computer system to access a network resource;
transmitting, from the network application server to a network context server, a request for network context information about the client computer system;
acquiring, by the network context server from a network context database, network context information about the client computer system; and
transmitting, from the network context server to the network application server, network context information acquired by the network context server;
the network application server controlling access to the network resource by the client computer system based at least in part on the acquired network context information.

2. The method of claim 1, wherein the network context information includes health of the client computer system.

3. The method of claim 2, wherein the health of the client computer system includes information about at least one of anti-virus software installed on the client computer system and a level of firewall protection configured in relation to the client computer system.

4. The method of claim 1, wherein the network context information includes information about a network connection of the client computer system.

5. The method of claim 1, wherein the network context information includes authorization status of the client computer system.

6. The method of claim 1, further comprising:
receiving, by a network access controller, a request to access the computer network from the client computer system;
receiving, by the network access controller, network-level credentials from the client computer system;
receiving, by the network access controller, network context information about the client computer system;
transmitting, from the network access controller to an Authentication, Authorization and Accounting (AAA) computer system, the network level credentials and network context information;
storing, by the AAA computer system into the network context database, the network context information.

7. The method of claim 6, further comprising:
authenticating the network-level credentials against a credential database;
generating, by the AAA computer system, an authentication response from a result of the authentication against the credential database; and
transmitting, by the AAA computer system, the authentication response to the network access controller.
generating, by the AAA computer system, an authorization response adapted to be used by a network access controller to control access to the computer network by the client computer system, the authorization response being based at least partially on the network context information; and
transmitting, by the AAA computer system, the authorization response to the network access controller.

8. A computer system for controlling access to a computer network, the computer system being configured to:
receive network-level credentials from a network access controller, the network-level credentials being associated with a client computer system attempting to gain access to the computer network;
receive network contest information from the network access controller, the network context information including information about the client computer system;
store the network context information in a network context database;
authenticate the network-level credentials against a credential database;
generate an authentication response from a result of the authentication against the credential database;
generate an authorization response adapted to be used by a network access controller to control the client computer system's access to the computer network, the authorization response being based at least in part on the network context information; and
transmit the authentication and authorization responses to the network access controller.

9. The computer system of claim 8, wherein the network context information includes information about the network connection of the client computer system.

10. The computer system of claim 8, wherein the network context information includes health of the client computer system.

11. The computer system of claim 10, wherein the health of the client computer system includes information about at least one of anti-virus software installed on the client computer system and a level of firewall protection configured in relation to the client computer system.

12. The computer system of claim 8, further configured to:
acquire additional network context information, the additional network context information including information about the network access controller;
store the additional network context information in the network context database; and
generate the authorization response further based at least in part on the additional network context information.

13. The computer system of claim 8, further configured to:
acquire additional network context information from the credential database, the additional network context information including information about a user of the client computer system; and
store the additional network context information received from the credential database in the network context database; and
generate the authorization response further based at least in part on the additional network context information.

14. The computer system of claim 18, further configured to:
receive a request for network context information about the client computer system from a network application;
acquire the requested network context information from the network context database; and
transmit the acquired network context information to the network application.

15. The computer system of claim 8, further configured to store additional network context information, including authorization status of the client computer system in the network context database.

16. A computer system for providing network context information to one or more network applications, the computer system being configured to:
receive a request for network context information from a network application, the network context information relating to a client computer system executing a client application that is communicating with the network application;
acquire the requested network context information from a network context database; and
transmit the acquired network context information to the network application.

17. The computer system of claim 16, wherein the request for network context information is received in a Service Oriented Architecture Protocol (“SOAP”) packet, and the acquired network context information is transmitted to the network application in a SOAP packet.

18. The computer system of claim 16, wherein the network context information includes information about a network connection of the client computer system.

19. The computer system of claim 16, wherein the network context information includes health of the client computer system.

20. The computer system of claim 19, wherein the health of the client computer system includes information about at least one of anti-virus software installed on the client computer system and a level of firewall protection configured in relation to the client computer system.

21. The computer system of claim 16, wherein the network context information includes authorization status of the client computer system.

22. A storage medium, readable by a first processor of a first computer system, having embodied therein a first computer program of commands executable by the first processor, the program being adapted to be executed to:
receive over a computer network a request for access to a network resource from a client application executing on a client computer system;
transmit over the computer network a request for network context information about the client computer system to a second computer system executing a network context service;
receive from the second computer system network context information about the client computer system;
grant the client application access to the network resource based on the network context information.

23. The storage medium of claim 22, wherein the network context information includes health of the client computer system.

24. The storage medium of claim 23, wherein the health of the client computer system includes information about at least one of anti-virus software installed on the client computer system and a level of firewall protection configured in relation to the client computer system.

25. The storage medium of claim 22, wherein the network context information includes information about a network connection of the client computer system.

26. The storage medium of claim 22 wherein the network context information includes authorization status of the client computer system.

27. The storage medium of claim 22, wherein the request for network context information is transmitted over the computer network to the second computer system in a Service Oriented Architecture Protocol (“SOAP”) packet, and the requested network context information is received over the computer network from the second computer system in a SOAP packet.

28. A storage medium, readable by a processor of a client computer system, having embodied therein a first computer program of commands executable by the processor, the program being adapted to be executed to:
transmit a request for access to a computer network to a network access controller residing on the computer network;
receive a request for network-level credentials from the network access controller;
acquire network-level credentials:
transmit the network-level credentials to the network access controller;
acquire network context information about the client computer system;
transmit the network context information to the network access controller; and
thereafter, receive permission to access the computer network from the network access controller.

29. the storage medium of claim 28, wherein the network context information includes information about a network connection of the client computer system.

30. The storage medium of claim 28, wherein the network context information includes health of the client computer system.

31. The storage medium of claim 30 wherein the health of the client computer system includes information about at least one of anti-virus software installed on the client computer system and a level of firewall protection configured in relation to the client computer system.

32. A system for implementing context-based security on a computer network, the system comprising:
at least one network application server;
a network context server; and
a network context database;
wherein the at least one network application server is configured to:
receive, from a client application executing on a client computer system, a request to access a network resource;
transmit, to the network context server, a request for network context information about the client computer system;
receive, from the network context server, network context information about the client computer system;
control the client application's access to the network resource based on the network context information;
and wherein the network context server is configured to:
receive, from the at least one network application server, a request for network context information about the client computer system;
acquire, from the network context database, network context information about the client computer system; and
transmit, to the network application server, the acquired network context information.

33. The system of claim 32, wherein the network context information includes health of the client computer system.

34. The system of claim 33, wherein the health of the client computer system includes information about at least one of anti-virus software installed on the client computer system and a level of firewall protection configured in relation to the client computer system.

35. The system of claim 32, wherein the network context information includes information about a network connection of the client computer system.

36. The system of claim 32, wherein the network context information includes authorization status of the client computer system.

37. The system of claim 32, further comprising:
a network access controller; and
an authentication, authorization and accounting (AAA) computer system;
wherein the network access controller is configured to
receive a request to access the computer network from the client computer system;
transmit to the client computer system a request for network-level credentials;
receive network-level credentials from the client computer system;
receive network context information about the client computer system;
transmit to the AAA computer system the network level credentials and network context information;
and wherein the AAA computer system is configured to:
authenticate the network-level credentials against a credential database;
generate an authentication response from a result of the authentication against the credential database;
transmit the authentication response to the network access controller; and
store the network context information in the network context database.

38. The system of claim 37, wherein the AAA computer system is further configured to:
generate an authorization response adapted to be used by a network access controller to control the client computer system's access to the computer network, the authorization response being based at least partially on the network context information; and
transmitting the authorization response to the network access controller.

39. The system of claim 37, wherein the AAA computer system is further configured to acquire and store additional network context information from the credential database, the additional network context information including information about a user of the client computer system.
